(19) United States
(12) Patent Application Publication
(10) Pub. No.: US 2003/0200142 A1
(43) Pub. Date: Oct. 23, 2003

(54) On-line employee incentive system

(76) Inventors: Heather Hicks, Richmond, VA (US); Marti Lazear, Richmond, VA (US)

Correspondence Address: ROTHWELL, FIGG, ERNST & MANBECK, P.C., 1425 K STREET, N.W., SUITE 800, WASHINGTON, DC, 20005, US

(21) Appl. No.: 10/127,492

(22) Filed: Apr. 23, 2002

(51) Int. Cl. G06F 17/60

(52) U.S. Cl. 705/14

(57) ABSTRACT

A method and system for administering and redeeming accumulated employee loyalty points over a distributed computer network such as a company's Intranet or the Internet is disclosed. In general, the method includes two web-based modules which deliver the program to the employer/employee and interconnectivity to external systems. An employer administrative module allows managers to easily award points as well as run reports to track incentive activity. The employee module allows employees to check and redeem their points online. Employees can earn points for defined behaviors including perfect attendance, meeting sales quotas, or meeting a project deadline. The employee module offers secured login and handles point redemptions for items including certificates, merchandise, and travel. In addition to these modules, interconnectivity to various Human Resources Information Systems (HRIS), payroll, and compensation systems is provided. A second aspect of the present invention is generally characterized in an online employee loyalty system implementing the above method.

### BACKGROUND OF THE INVENTION

1. Field of the Invention

The present invention relates generally to employee loyalty programs and, in particular, to an online employee loyalty system and method for administering and redeeming accumulated employee loyalty points over a distributed computer network such as a company's Intranet or the Internet.

2. Background and Related Art

In today's economy, companies are expected to be flexible and dynamic in reaction to market conditions. A new, unwritten understanding of the relationship between employers and employees has evolved—one that does not guarantee job security, but instead commits to enhancing employees' marketable skill sets. Employers benefit with increased productivity by emphasizing concern of the employees' overall welfare and having a well-trained workforce. Employees benefit from enhanced skills and the ability to more easily manage the demands of life and work.

Recognition and incentive programs have emulated this evolution and are moving away from cash and stock awards, which reflect the volatility of the marketplace and lack of personalization. Instead, companies are focusing on non-cash awards that are based on specific and measurable performance. Non-cash awards minimize the chance the employee will use the bonus for expenses, and have been repeatedly proven to have more “trophy” or memory value. Part of the value of a recognition program is that employees see others getting recognized and aspire for the same award. If an employee receives a cash award, he/she is not likely to share the amount of the award with other people in the organization; the company loses the promotional value of good performance. Non-cash awards give employees something to talk about with their peers and provide a lasting reminder of recognition of a job well done.

Employers want employees to achieve many performance goals such as perfect attendance and monthly sales goals. The recognition of these desired behaviors can be connected to an ongoing rewards program, which offers increased value for the most important achievements. Points programs are proven to drive desired consumer behavior in many industries. As employees accumulate points towards tangible awards, they will make the psychological investment in the company and continue to perform as desired. The net effect of a successful employee points program is increased employee loyalty and improved bottom line company results.

Many companies realize the value of non-cash rewards, but no efficient applications existed to manage the cumbersome process of managing eligibility, award acquisition/fulfillment, communication, or payroll taxes. Now, the prevalence of the Internet and advancing technologies have created more effective strategies and applications and incentive programs can be managed.

Consumer-based points reward programs are common. One example is an airline frequent flier program, in which a customer accumulates points (or “miles”) by purchasing flights from a participating airline. The points can be redeemed for additional flights, gift certificates, merchandise, or airline services such as upgrades and lounge privileges. Similar programs exist in other consumer markets. Consumer based incentive award programs are described in U.S. Pat. No. 5,774,870 and U.S. Pat. No. 6,009,412, the respective disclosures of which are hereby incorporated by reference.

Employee loyalty programs operate similarly. The points offered by a provider have a standard value. For example, employers may reward customers for perfect attendance, meeting sales quotas, meeting a project deadline, or for any other noteworthy accomplishment. Employees can redeem their points by selecting from a standard offering of a limited selection of merchandise gift certificates. Additionally, current providers of employee reward programs provide fully customized solutions which have high startup costs, making them a non-viable option for small to mid-sized companies.

Furthermore, current web portal based programs are dependent on advertising revenue. There continues to exist a need for an Intranet/Internet based employee rewards program that addresses all of these shortcomings.

### SUMMARY OF THE INVENTION

A first aspect of the present invention is characterized in a method of administering and redeeming accumulated employee loyalty points over a distributed computer network such as a company's Intranet or the Internet. In general, the method includes providing two modules based on a distributed network which deliver the program to an employer and an employee. Additionally, the method provides for interconnectivity to external systems, such as payroll and human resource information systems.

The present invention is an interactive incentive solution designed to assist an employer-client with the retention of key employees by providing, the motivating power of a points-based incentive program communicated, delivered, and managed over the Internet or the employer's intranet. Web-based, customizable and easy to administer, the present invention provides the opportunity to capitalize on every employee-manager interaction.

The present invention enables the employer-client to provide:

a performance driven rewards distribution vehicle for timely recognition;

instant communication of recognition to the employee;

customized earning activities, reward options, and reporting;

a program tailored to business units, locations, or even specific jobs;

a medium to measure consistency and equity across the organization;

and a paperless and secure audit trail for payroll and HR purposes.

The incentive component of the present invention allows employees earn points redeemable for appealing rewards, including merchandise, gift certificates, travel, and more. Employees can earn points for defined behaviors the employer-client wants to incent and recognize. The present invention gives companies a consistent vehicle for tracking incentive dollars by creating an audit trail of incentives awarded and redeemed.

The on-line employee incentive program includes two web-based modules, which deliver the program to the client and the employee. An administrative Module allows managers to easily award points, as well as run reports to track and analyze incentive activity. The module can be implemented and maintained by receiving data transfers from various human resources management systems, payroll and compensation systems.

An employee communication module, or portal, allows employees to check and redeem their points online. The portal can be customized to provide interesting program related content and access to special services that improve employee knowledge of other benefit plans. The portal functions as a consistent and timely corporate communication vehicle and provides opportunities to share company news and benefit information.

A system provider will host and maintain the entire employee incentive program site including the administrative module and the employee communication portal. In addition, the system provider will provide database management for the program including point tracking, point redemption, program accounting and reporting. All program materials and communications can be customized to reflect your company's logo and image.

### BRIEF DESCRIPTION OF THE DRAWINGS

FIG. 1 is a flowchart illustrating the relationships between the relevant participants in the employee loyalty program.

FIG. 2 is an exemplary table identifying reward point-earning activities and reward point levels.

FIG. 3 is an exemplary reward point-award option-award value matrix.

FIG. 4 is a flowchart illustrating the major components of the employee loyalty program.

FIG. 5 is a flowchart illustrating the functions of the employee administrative module.

FIG. 6 is a flowchart illustrating the functions of the employee module.

FIG. 7 is a screen shot depicting the new employee activation screen of the employee module.

FIG. 8 is a screen shot depicting the login screen of the employee module.

FIG. 9 is a screen shot depicting the forgot password-account number screen of the employee module.

FIG. 10 is a screen shot depicting the forgot password-security question screen of the employee module.

FIG. 11 is a screen shot depicting the forgot password-reset password screen of the employee module.

FIG. 12 is a screen shot depicting the account summary screen of the employee module.

FIG. 13 is a screen shot depicting the program information/program overview screen of the employee module.

FIG. 14 is a screen shot depicting the program information/earning points screen of the employee module.

FIG. 15 is a screen shot depicting the program information/program rules screen of the employee module.

FIG. 16 is a screen shot depicting the terms of use screen of the employee module.

FIG. 17 is a screen shot depicting the program privacy policy screen of the employee module.

FIG. 18 is a screen shot depicting the frequently asked questions screen of the employee module.

FIG. 19 is a screen shot depicting the customer service screen of the employee module.

FIG. 20 is a screen shot depicting the update profile screen of the employee module.

FIG. 21 is a screen shot depicting the employee survey screen of the employee module.

FIG. 22 is a screen shot depicting the employee rewards screen of the employee module.

FIG. 23 is a screen shot depicting the merchandise redemption screen of the employee module.

FIG. 24 is a screen shot depicting the gift certificate redemption screen of the employee module.

FIG. 25 is a screen shot depicting the travel redemption screen of the employee module.

FIG. 26 is a screen shot depicting the logout screen of the employee module.

### DETAILED DESCRIPTION OF THE PREFERRED EMBODIMENTS

An exemplary embodiment of an online employee loyalty system according to the present invention is described herein as being implemented over a distributed network such as a company's Intranet or the Internet. It will be appreciated, however, that the inventive system can be implemented over any communication medium including, but not limited to, local area networks, wide area networks, and dedicated dial-up connections.

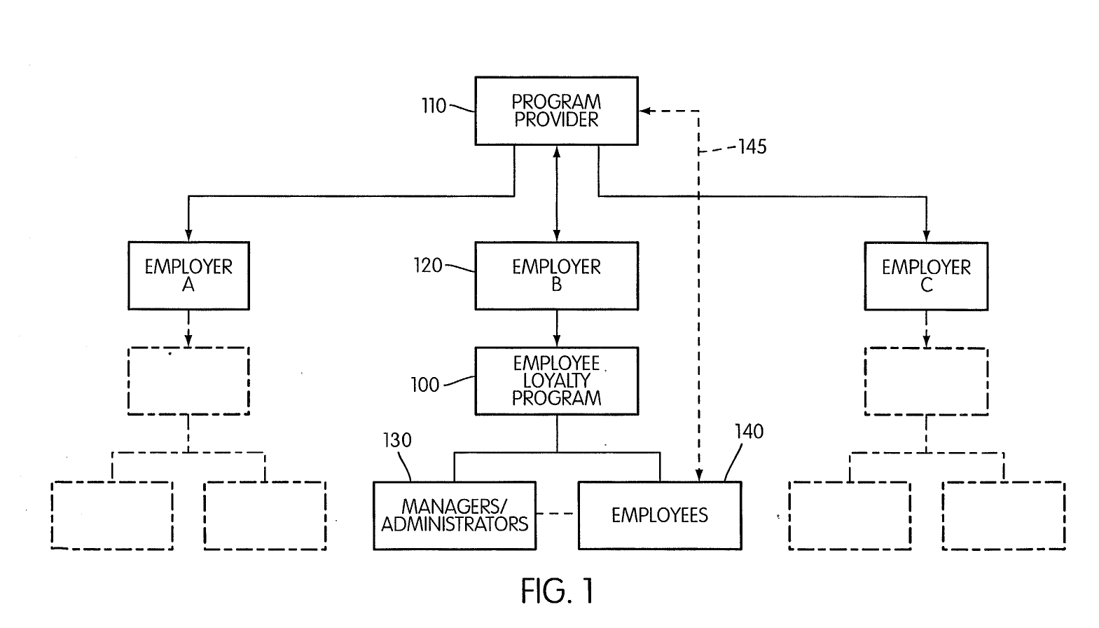

Referring now in detail to the drawings wherein like parts are designated by like reference numerals throughout, there is in FIG. 1 a flowchart that generally illustrates the relationship between the program provider 110, employer 120, managers/administrators 130, and employees 140. An employer 120 that desires to initiate an employee loyalty program 100 contacts a program provider 110 who designs and provide a program for the employer.

At the beginning of program implementation, the program provider 110 will begin a program design phase in which it collaborates with the employer-client 120 to understand the organizational structure of the employer and challenges faced by the employer as they relate to employee attrition, performance management, compensation, etc. The provider 110 will incorporate this knowledge into a program design in which the provider identifies:

the ways in which points will be earned;

rewards for which points may be redeemed;

the types of reports that will be necessary to measure performance;

the technical deployment strategy and required resources;

the marketing communications plan to promote the program;

the management of training implementing the program.

During the design phase, the provider gathers information that it will use to develop an offering of awards that is most appropriate to the particular employer-clients employees. In particular, the provider 110 will recommend a mix of awards that is most appropriate in consideration of:

employee demographics;

the dollar amount per employee which the employer has budgeted;

the earning capacity per employee (or the number of points an employee can earn in a period of time);

the frequency with which the employer would like to recognize employees.

More specific employee information will allow the provider to more effectively recommend a mix of awards for the employer's particular program. In a preferred embodiment of the present invention, the philosophy for selecting particular awards for a particular employer's program is based on each of a number of qualities integral to employee acceptance of the program. Employees who feel truly recognized by the rewards offered are more likely to focus on behavior that enable them to reach the reward and increase their investment in the employer.

### Rewards with High Perceived Value

While it is generally desirable that all of the awards provided be of high perceived value to the employees, some particular awards offer the employer the opportunity gain employee goodwill and benefit from a lower price. The “trophy value” of merchandise, for example, allows the provider to present a high value award at a better value proposition for the employee (lower point level) than airline tickets.

### Relevant, Aspirational, and Attainable Awards

Employees are consumers and they are incented by awards that are appealing and relevant to their needs and lifestyle. If award types are targeted to the particular employer's employees, the relevance of those awards increase the motivational power and strength of the program. It is desirable in the administration of the program of the present invention to control expenses for the employer and establish redemption levels that create a return on investments (i.e., provide the proper level of incentive) for the program. If redemption levels for awards seem out of reach, however, the motivation to perform and attain the awards is lost. A balance of several redemption levels and types of awards builds the perception of obtainability.

### Timely Recognition

Waiting months or even weeks, to recognize an employee for the employee's efforts is not as effective as the immediate recognition. The program of the present invention allows employers to recognize valuable behavior instantly, adding to the employees' acceptance of the program and desire to perform. An award matrix that is customized to the demographics and lifestyles of the employees and the quick fulfillment of awards generates excitement about earning reward points.

Reward points are purchased by the employer from the provider for issuing to selected employees. The per point redemption value of the points can be customized in accordance with the employer's needs and desires. The provider 110 has a relationship 145 with one or more businesses that provide the goods and services selected for each employer's award offering, and the provider will maintain an inventory of merchandise and gift certificates corresponding to the award offering.

Managers/administrators 130 administer the program, and employees 140 participate in and receive the benefits of the program. The program is a platform that may be provided, with little modification except for the customization of point redemption values and award offerings, to numerous employers 120, e.g., employers “A”, “B”, and “C” in FIG. 1, and the provider 110 is preferably linked electronically with the computer system on which each employer's incentive program is installed.

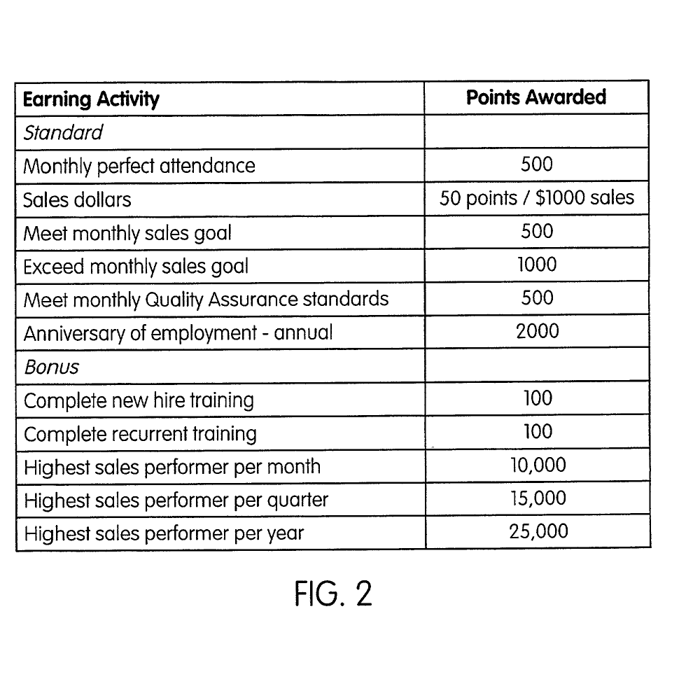

FIG. 2 shows an exemplary table defining the manner in which reward points may be earned and the number of points which may be earned for an employer whose business includes the sale of goods or services. As shown in the table of FIG. 2, various point-reward levels are defined for a plurality of behaviors, such as attendance goals, meeting sales goals, meeting quality assurance goals, completing training, and excelling in sales performance, that the employer wishes to incent. Point reward levels range from 50 points per thousand dollars of sales to 25,000 points for the highest sales performer per year.

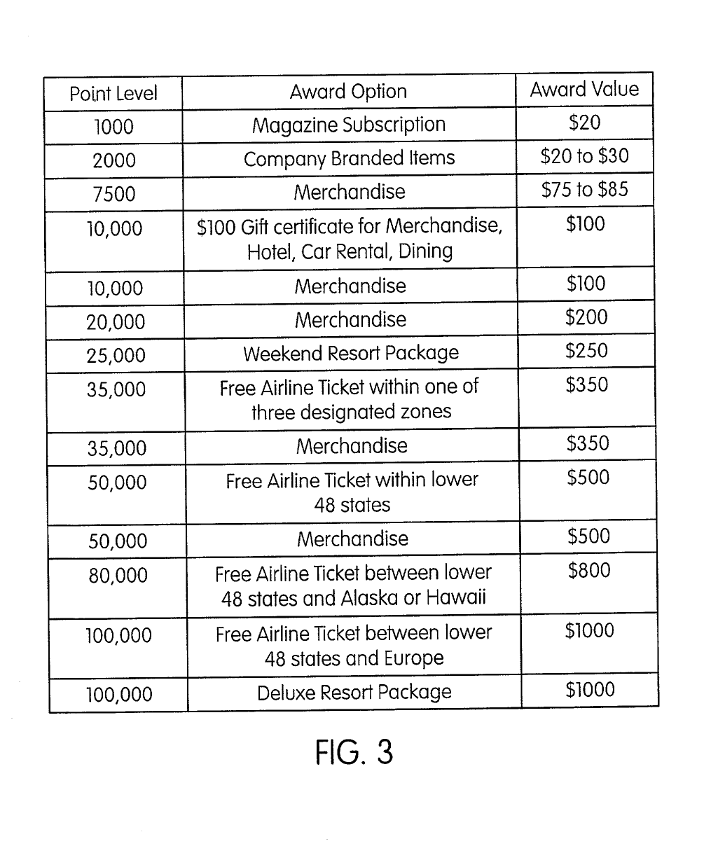

FIG. 3 is an exemplary table of an award offering developed for a hypothetical employee-client. The table in FIG. 3 defines the various award options, the number of reward points that must be available to redeem for a particular award, and the monetary value of particular award for tax reporting and accounting purposes. In the table shown in FIG. 3 general categories of award options are listed, for example magazine subscriptions, merchandise of varying values, gifts certificates for merchandise, hotel, car rental, or dining, and resort packages. In an actual award matrix developed for a specific employer, more specific award information would be provided. For example, under magazine subscriptions, a number of specific magazine offerings and number of issues per subscription would be listed, under merchandise, particular brand name items, e.g., brand x camera or brand y golf clubs would be listed, under gift certificates, specific businesses, e.g., retail stores, hotel chain, car rental chain, or restaurant chain would be listed, and under resort package, specific resorts would be identified.

The provider 110 will manage merchant/manufacturer approval, promotional materials approval, award acquisition, inventory, and award fulfillment. Awards can be added to the award offering on a permanent or a temporary, promotional basis.

Flow of information from the program provider 110 to the employer 120 can be accomplished in a mutually agreed upon format and frequency. Such formats may include, but are not limited to, direct communications such as dial-up networks or the Internet, or indirect communications such as floppy-discs or hard copy (paper) transmissions.

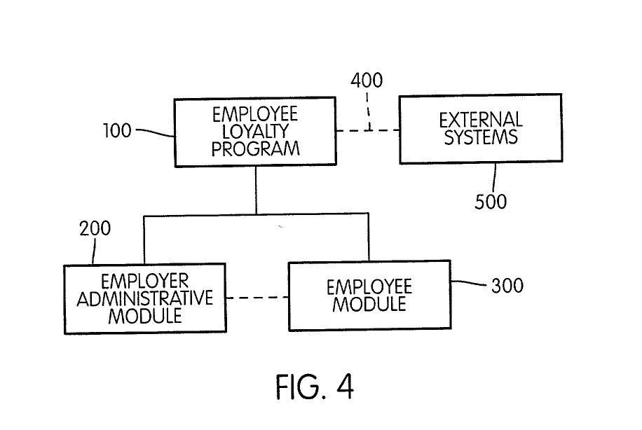

FIG. 4 is an embodiment of an employee loyalty program 100 implemented over a distributed network such as a company's Intranet or the Internet. The program includes two web-based modules, an employer administrative module, or portal, 200 (herein after administrative module) and an employee module, or portal, 300. As described herein, these modules interact with each other to provide the employee loyalty program 100 of the current invention. In addition to these modules, the system may provide for interconnectivity 400 to various external systems 500, such as payroll, compensation, and human resource information systems.

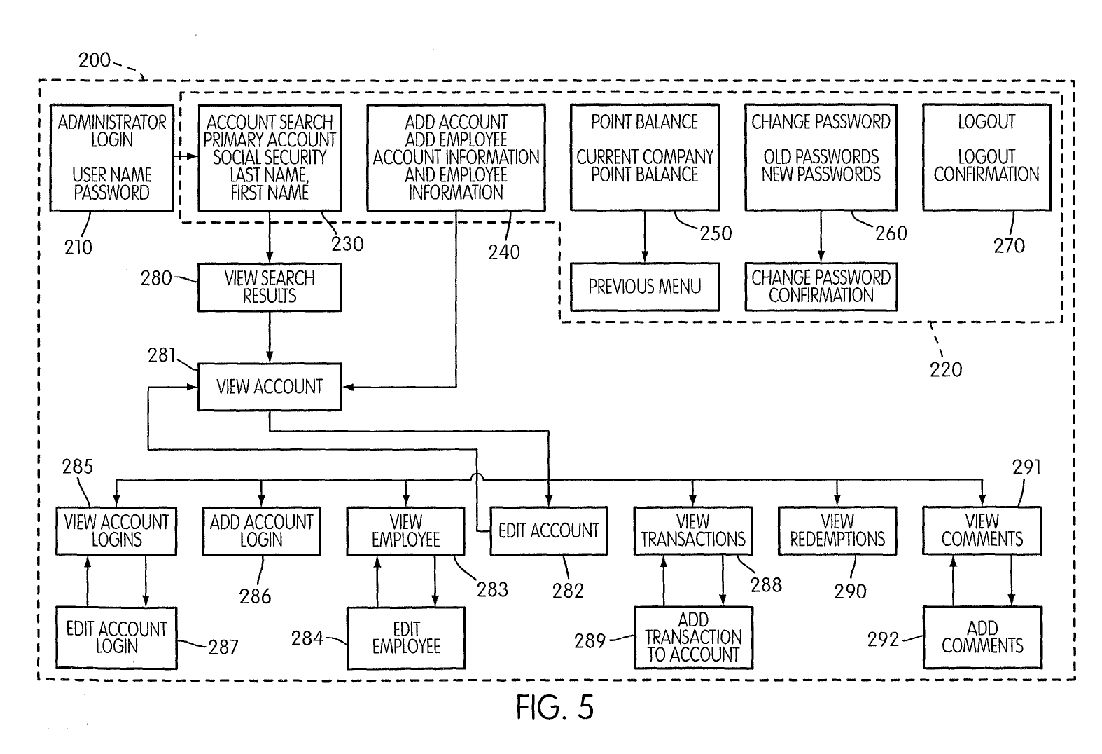

As illustrated in FIG. 5, the administrative module 200 provides an employer a communication portal with the functionality to manage and deliver the employee loyalty program 100 to employees. The management functions include program point purchase history and current point balance and program reporting for expense management and tax filing. The delivery functions include access to individual employee records, maintenance capabilities, and the creation of point transactions to the employee's account. In addition to this functionality, the administrative module 200 includes various security measures to ensure program confidentiality and authorized use.

Authorized users such as managers/administrators must login 210 in order to access the administrative module 200. Login requires users to provide a user name and two passwords. Once logged in, users will have access to a memory location containing the current points available for employee distribution on each page, as well as have the option to return to the home page, access help pages, and sign off of the administrative module. When a manager/administrator uses the administrative module for the first time, they will have to use a password supplied by the program provider 110. After the initial user has logged in for the first time, they may customize their passwords in the change password page 260, as discussed below.

The main menu within the administrative module is the administration panel 220. It provides a menu of options including: account search 230, add account 240, point balance 250, change password 260, and logout 270. These options can be accessed from any page when logged in. To ensure confidentiality and security regarding access to the program, the application will end a user session after five minutes of inactivity. If the user's session expires, a notification message will appear and prompt the user to repeat the login process 210. These features are described in more detail as follows.

The account search page 230 allows managers/administrators 130 access to memory locations corresponding to individual employees' 140 accounts in order to view account or employee information, edit account or employee information, view earning and redemption activities, add point transactions, view account comments, add account comments, edit employee account login, and add employee account login. These features are described in more detail below.

By utilizing an employee search function that is driven by identifying information such as last/first name and/or social security number, managers/administrators can view search results 280 and select an individual employee's account.

The view account page 281 provides information such as employee location, account number, account open date and program enrollment date, current account status, closed account information (if applicable), total points earned in program, total points redeemed in program, total points expired in program, current points balance, and employee login information. From the view account page 281 the user can access the edit account page 282 to change relevant account information. In addition to this account-specific information, the user can view employee demographic information by selecting the view employee page 283. This information can be edited by selecting the edit employee page 284.

A historical record of employee login information is available at the view account logins page 285. New logins can be created at the add account login page 286. The edit account login page 287 allows users to reset employee passwords in the event that the employee has forgotten it. Additionally, the user can use this page to lock an employee out of the system in the event the employee is terminated or their employment status changes.

The view transactions page 288 provides detailed point earning transaction information on an individual employee's account. In addition, basic account summary information is provided such as point balance, points earned, points redeemed, and points expired. From this page, users select the add transaction page 289 in order to add a point earning transaction to an individual employee's account. The page includes account summary information in addition to fields to enter transaction date, transaction code, custom description, and points awarded. Points can be awarded in the following general categories: bonus points, commission points, enrollment points, management by objective (MBO) points, reinstatement points, and retention points. During implementation, administrators can determine customized transaction descriptions to describe the specific employee event being recognized. Each new points transaction entered into the system preferably automatically generates a message to the employee recipient, such as an e-mail or a printed message on the employee's next paycheck.

The view redemptions page 290 provides information on the redemption transactions completed by the employee. Information includes redemption date, date reward fulfilled, reward description, and additional cost to the employee (if applicable). Additional cost to the employee may be incurred, for example, if an employee redeemed points for an airline ticket which exceeded the maximum value for the ticket as defined by the program's terms and conditions.

The view comments page 291 is accessed to see any comments entered on an individual employee's account. Users can enter comments on an account by selecting the add comments page 292. An illustrative comment might be: “Updated employee's address.”

Returning to the administration panel 220, authorized users can add new employees to the system through the add account page 240. Required employee information includes employee location, account number, account status, hire date, enrollment date, login ID, and employee demographics.

The point balance page 250 provides a record of the points purchased from the program provider 110 throughout the life of the program. Information displayed includes: the date the points were entered into the program points balance; the number of points per purchase; and the user requesting a point purchase.

The user can select the change password page 260 from the administration panel 220. The change password page will appear whenever passwords have expired and need to be reset. Periodic expiration of passwords is an added security feature that minimizes the detrimental impact of unauthorized access to the administrative module. To change the first password, the user must enter the original password, followed by a new password which must be re-entered to ensure accuracy. This procedure is repeated to change the second password.

The logout page 270 allows the user to exit the administrative module when desired. The user can opt to login again from this page.

In addition to the features listed above, an administer users page (not depicted) may be provided to allow managers/administrators to view a list of authorized users of the administrative module. Users with appropriate authority can add new authorized administrators through this page. Users can be set up with various levels of access including read only; read and add/void points transactions; or read and write on all records. For example, lower management may be provided only with read-only access to data, upper management may have authority to read and add or void transactions, and administrators may have authority to read and write all records.

Additionally, functionality may be provided to allow authorized users to access standard reports created by the program provider 110 to view program transaction history, redemption activity, rewards liability and tax information. Reports can be selected based on the date range desired and are automatically made available to the employer on a monthly basis. Employers can also request customized reports.

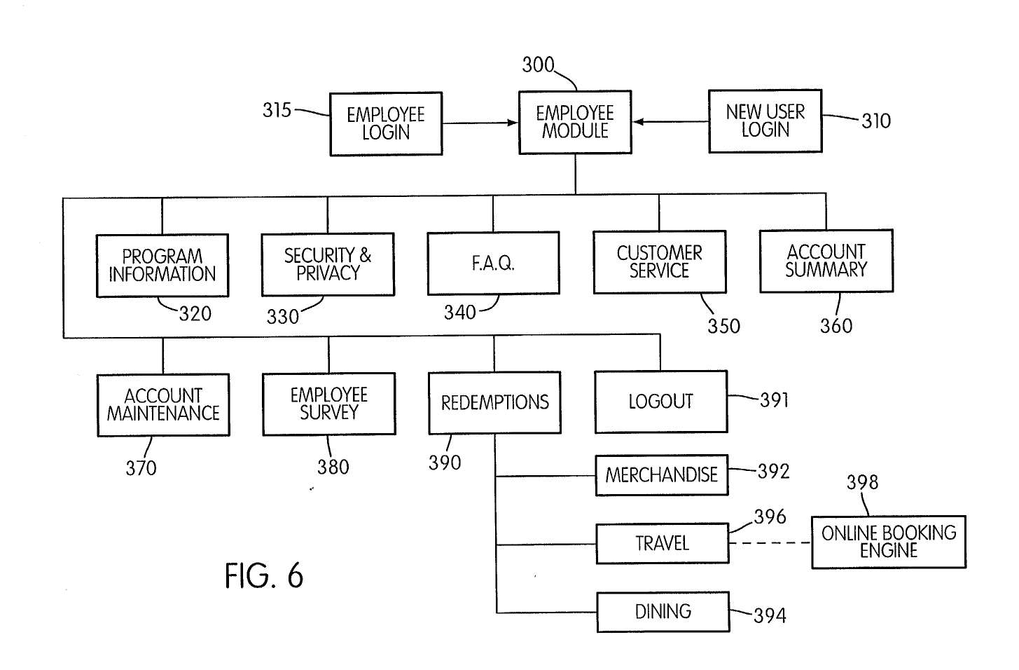

A detailed overview of the employee module 300 is depicted in FIG. 6. The interface with the employee is one of the keys to success of the employee loyalty program 100. The employee module 300 is designed to provide as much program information as necessary to be user-friendly. The employee module displays program and account information. The employee module provides a communication portal that enables the employee to have access to a memory location corresponding to that employee's account. In addition, it offers secured login and handles point redemptions for items, including certificates, merchandise, and travel. If the employee loyalty program 100 is implemented over the Internet, the employee module 300 offers the employee 140 instant access to account information and redemption options from any location where the employee has access to the Internet, at any time of the day.

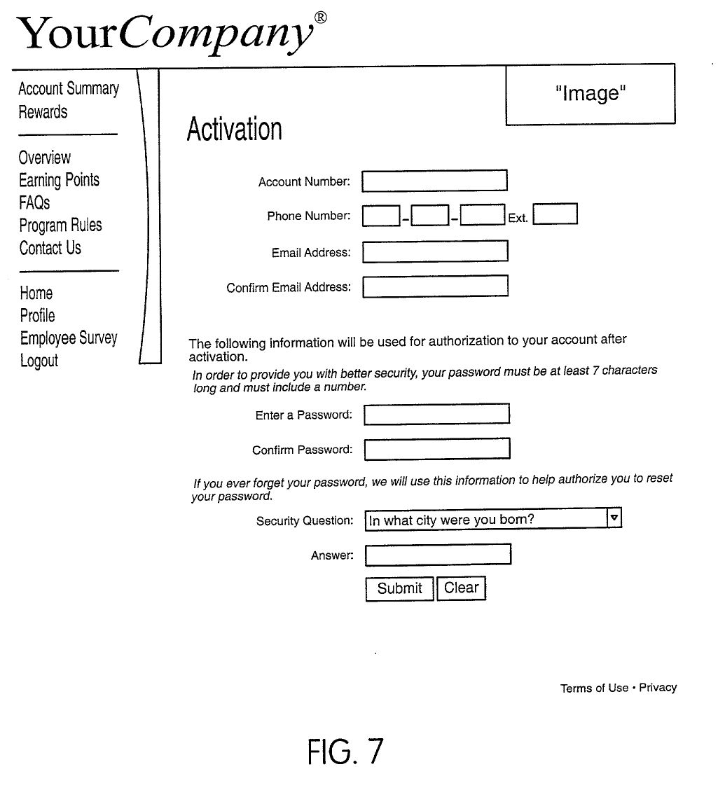

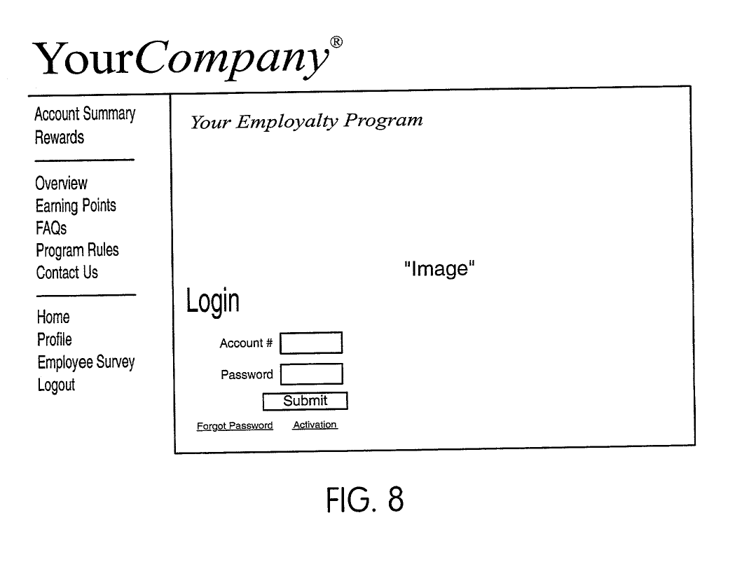

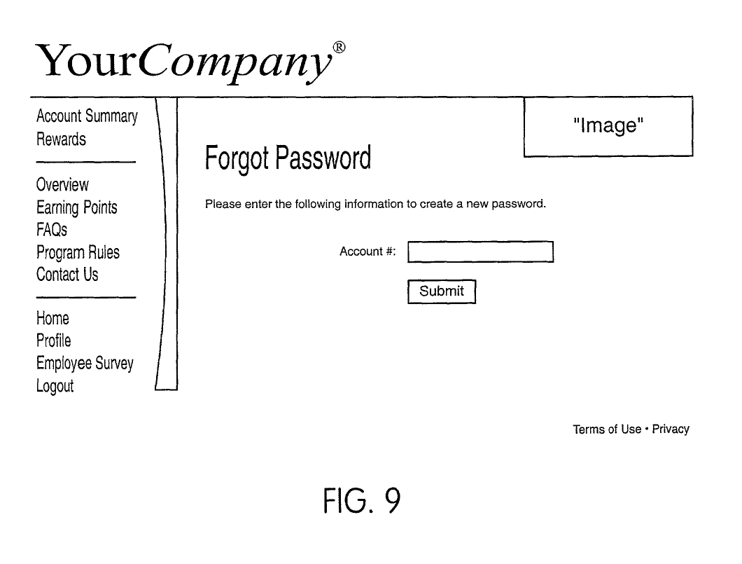

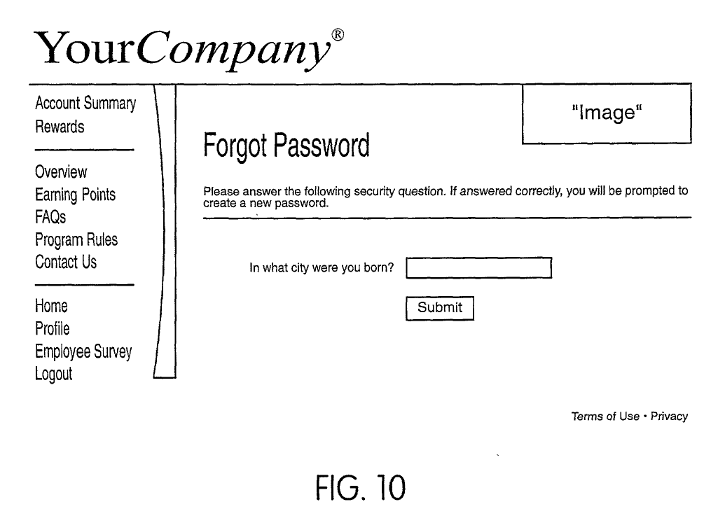

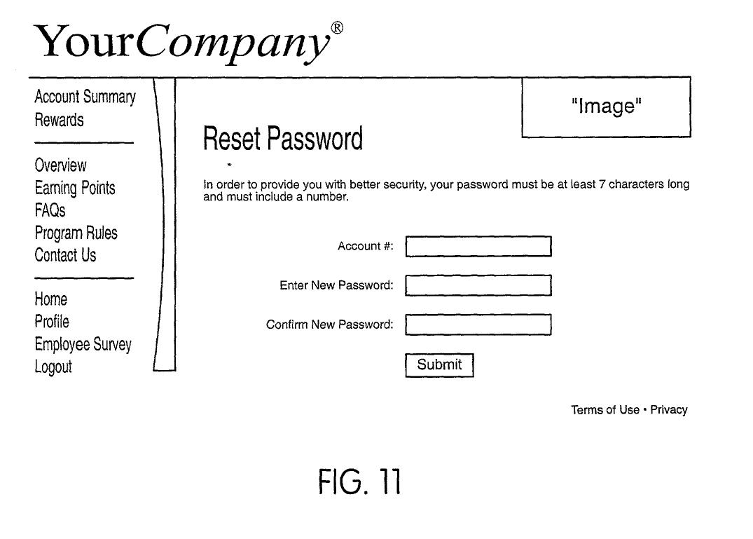

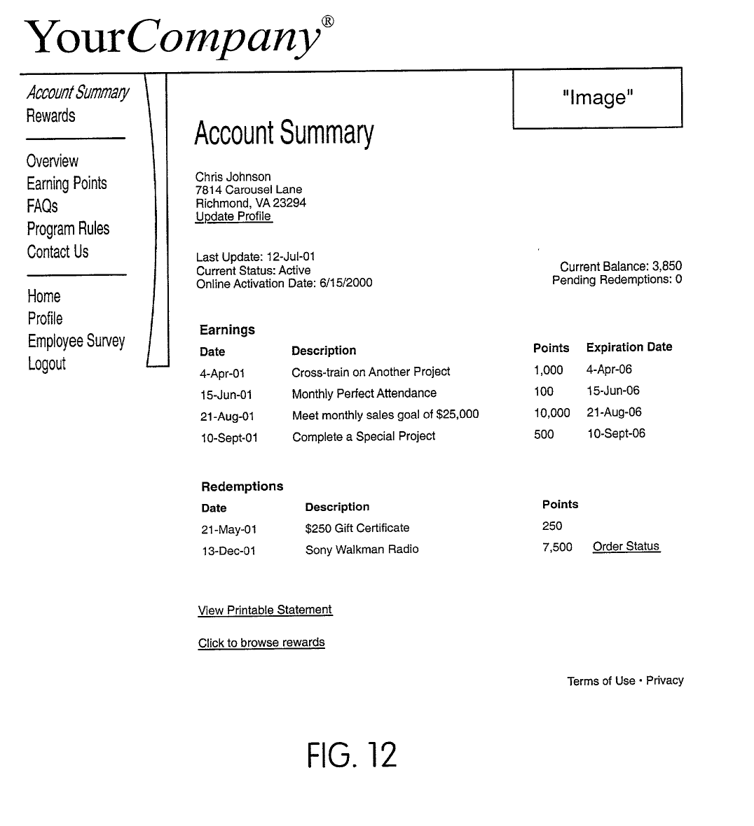

In order to access the employee module 300, employees must login. As illustrated in FIG. 6, new employees must use the new user login, or activation, page 310, an example of which is shown in FIG. 7, where they register by entering a pre-assigned account number and other information, such as telephone number and e-mail address, if applicable, and select a password for confidential access to their information. Employees who have already registered in the program access the employee module through the employee login page 315, an example of which is shown in FIG. 8, which would typically require the employee to enter an account number and password to gain access to the system. Upon entry to the site, the individual employee's point balance is displayed. If an employee forgets their password they can select the forgot password link located on the employee login page 315. If the employee correctly enters their account number, as shown in FIG. 9, and properly answers a security question, as shown in FIG. 10, their password will be reset and they can create new one, as shown in FIG. 11. Once login has been completed, the employee is directed to the account summary page 360, an example of which is shown in FIG. 12, and will have access to the features of the employee module. For example, the account summary page 360 may provide an up-to-date summary of each employee's individual account. Employees can view up to 6 months of point redemption transactions and can print out an account statement. Accessible information includes the employee's current balance, activity dates and descriptions, and earning and redemption activity as well a the date of last account update and point expiration dates.

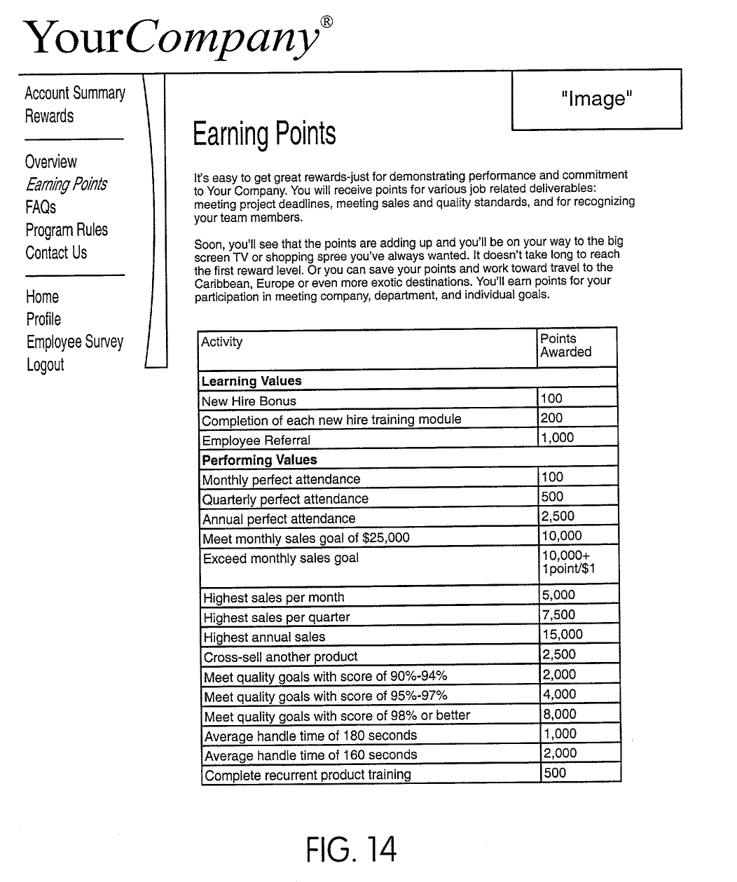

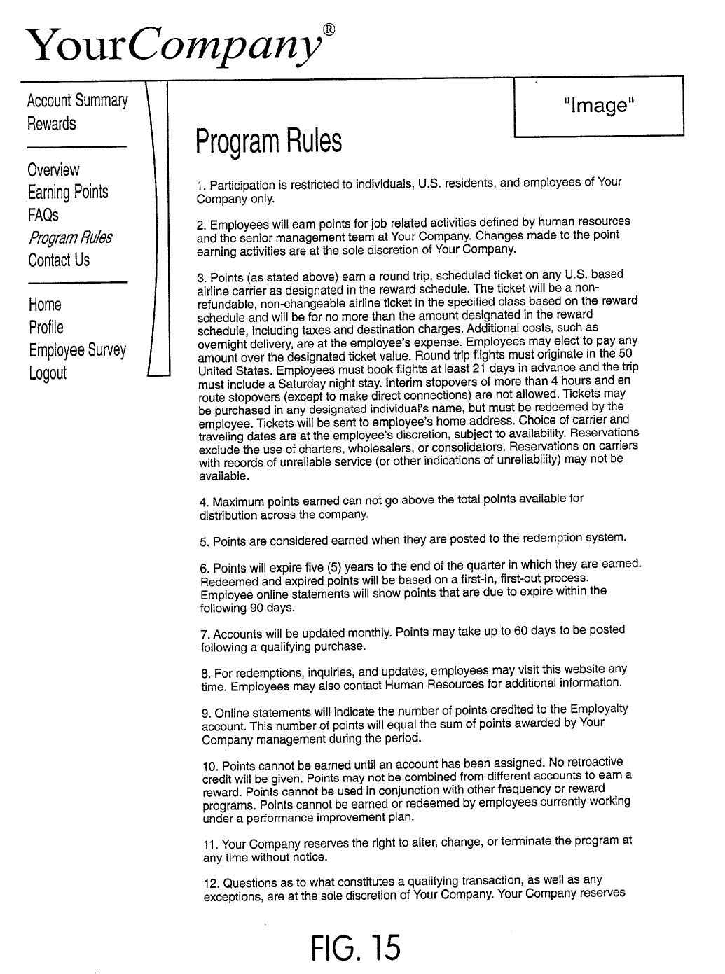

The program information pages 320 offer information such as program overview (FIG. 12), how to earn and redeem points (FIG. 14), rewards available in the program, and rules that apply to the program (FIG. 15).

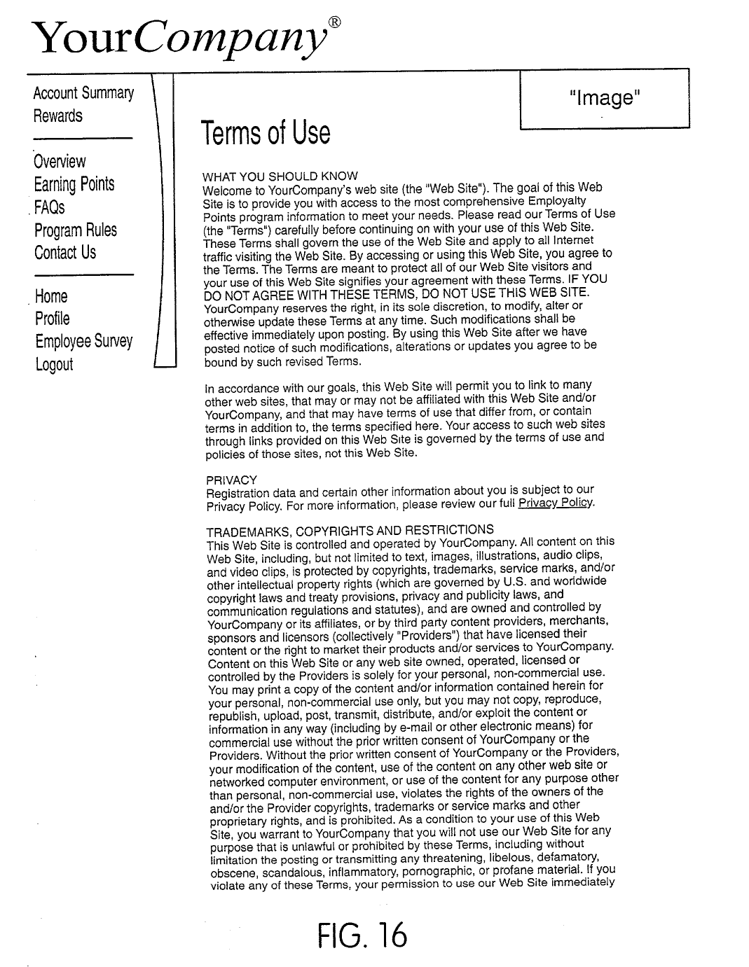

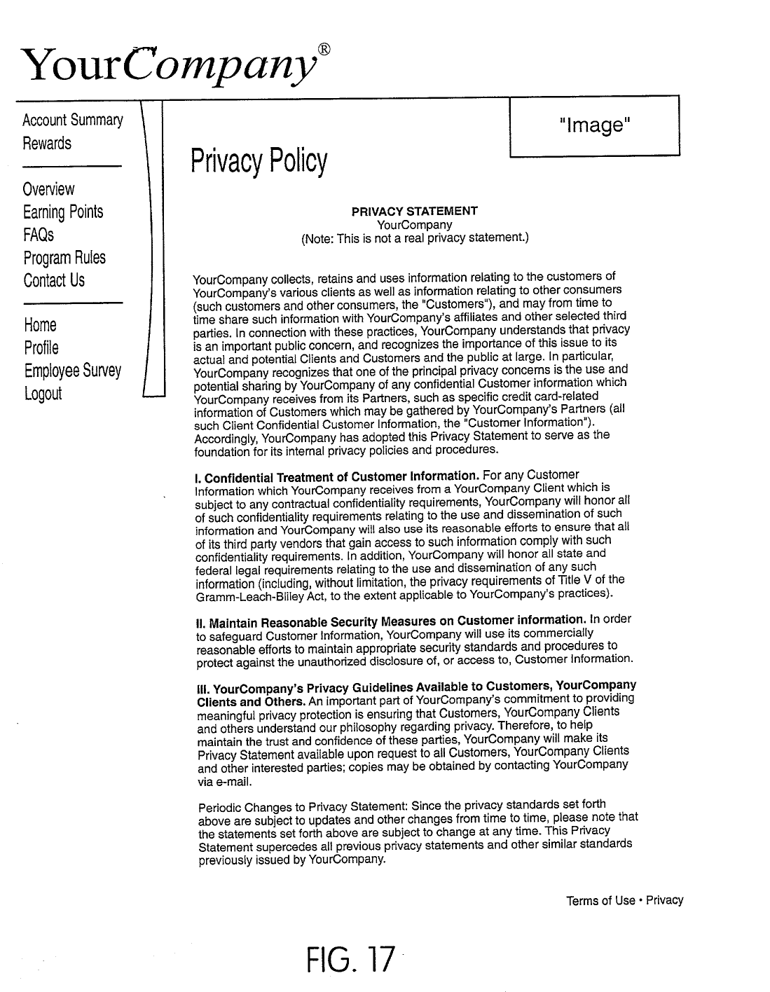

The security and privacy pages 330 detail the security and privacy policies, for example, with a Terms of Use page (FIG. 16) and a Privacy Policy page (FIG. 17), of the site and will assure employees of the safety of using the site for checking points and requesting awards online. Because all information is exchanged in strict confidence, employees are assured of their privacy when using the program. As discussed, each user must register when first visiting the site and must then login during each additional visit. All employee accounts are password protected and multiple security layers are included, such as user name, password, and PIN. Account access is locked after three failed login attempts.

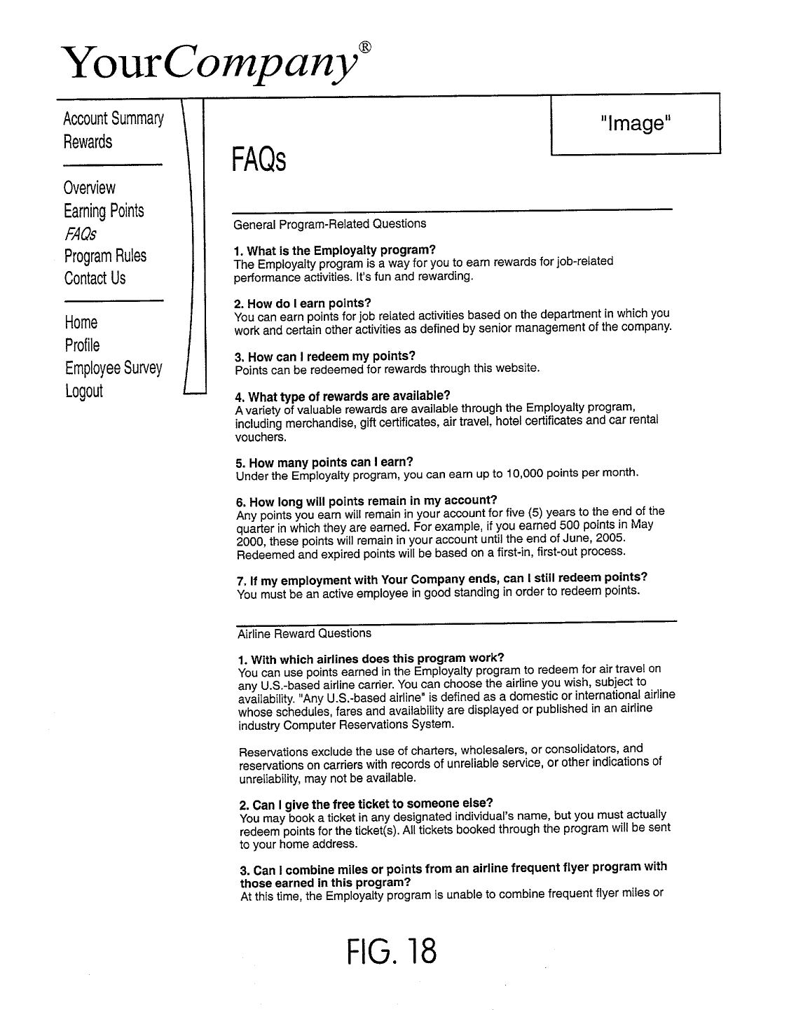

The frequently asked questions (F.A.Q.) pages 340, an example of which is shown in FIG. 18, include information about how to use the program and other program information employees may need.

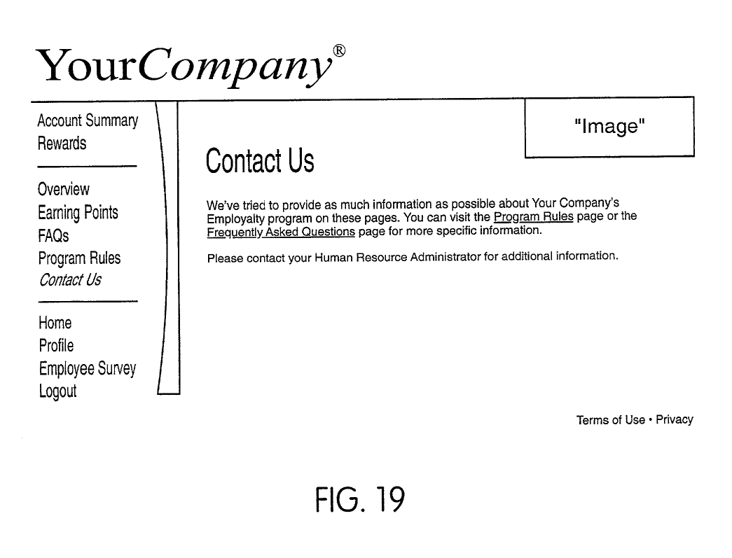

The customer service page 350, an example of which is shown in FIG. 19, communicates contact information for questions regarding the site or the program. The employer's Human Resources or program management team will answer all employee questions. This is accomplished through interconnectivity 400 to external systems 500, as will be further explained below.

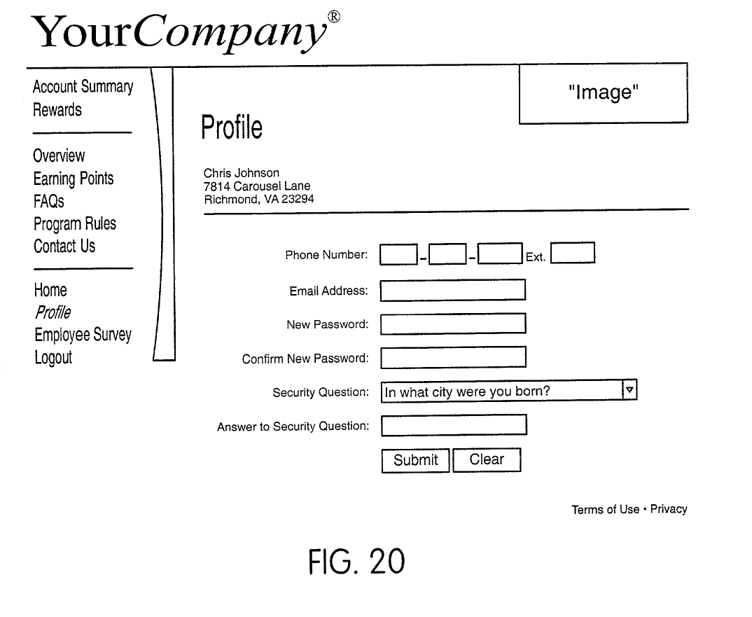

The account maintenance page 370, an example of which is shown in FIG. 20, enables an employee to change their password. For added security, in order to update information such as name, address, and home phone, the employee must contact a manager/administrator 130, who can effect these changes in the edit employee page 284 of the administrative module 200, as described above.

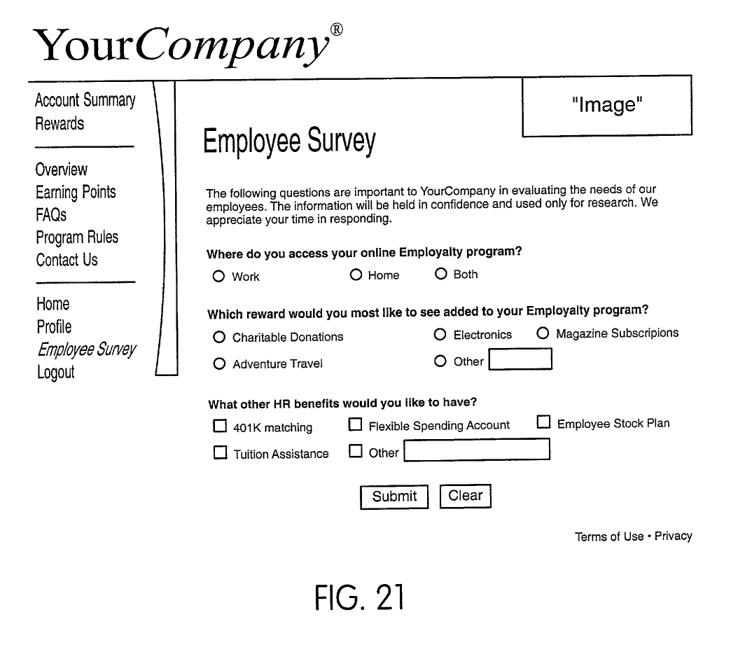

The employee survey page 380, an example of which is shown in FIG. 21, allows employees to fill out employee surveys that are sent to the program provider 110. Employers 120 may utilize this page to solicit feedback for other corporate purposes or to help the employer and provider modify the employee incentive program to optimize its value as an incentive tool. Employers define the customized survey and collaborate with the program provider 110 on development and delivery of results to the employer for analysis.

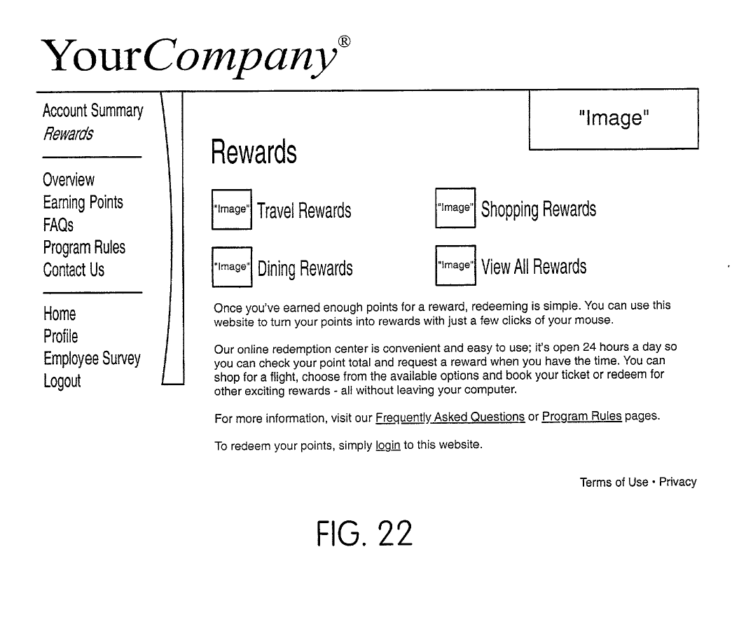

Employees redeem program points via a redemption portal 145 (see FIG. 1) for, e.g., magazine subscriptions, merchandise, gift certificates, and travel on the redemptions (or rewards) page 390, an example of which is illustrated in FIG. 22. As an added security measure, all rewards are mailed to the employee's home address on file. As shown in FIG. 22, redemption options may be grouped according to pre-defined categories, such as, travel, dining, or shipping (i.e., merchandise). The rewards page may include selectable links to any of these categories as well as a “View All Rewards” link which presents the employee with all redemption options.

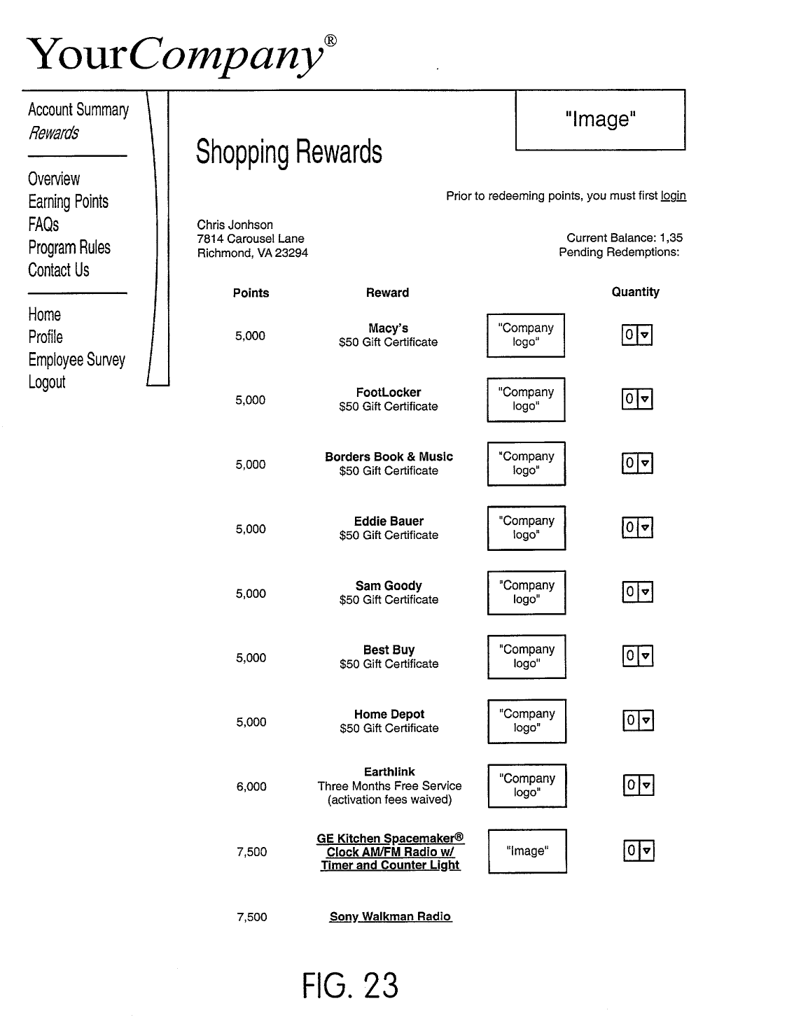

For merchandise redemptions 392, employees select from a list of merchandise options. The employee's redemption request is communicated to the provider, and the program provider 110 fulfills the merchandise request from an inventory of merchandise and gift certificates. A sample merchandise redemption page is shown in FIG. 23.

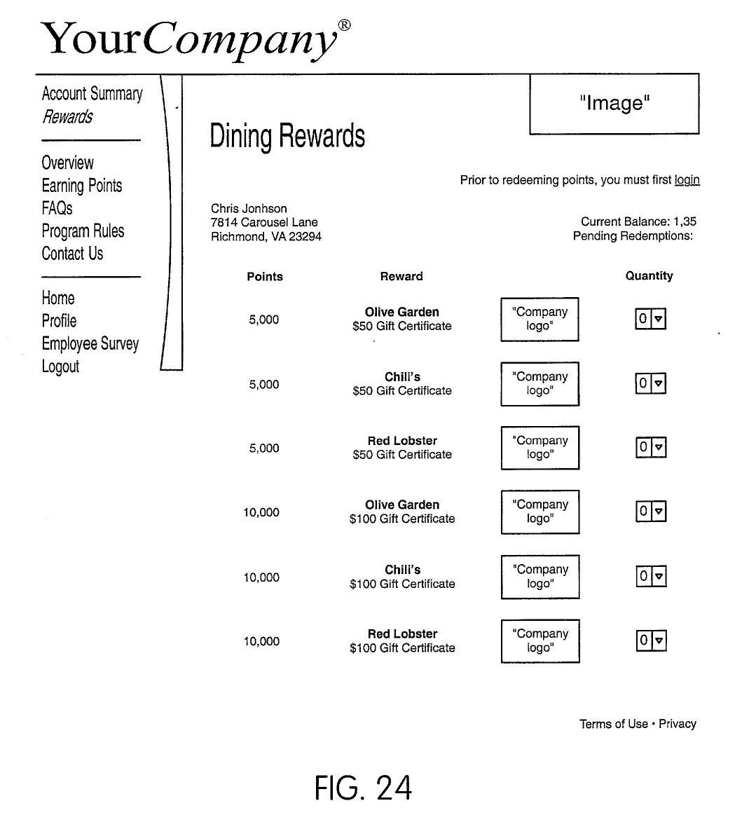

For dining redemptions 394, employees may select from a menu of reward options. The program provider 110 fulfills the redemption request by issuing a gift certificate of specified value at the dining establishment selected by the employee. A sample dining redemption page is shown in FIG. 24.

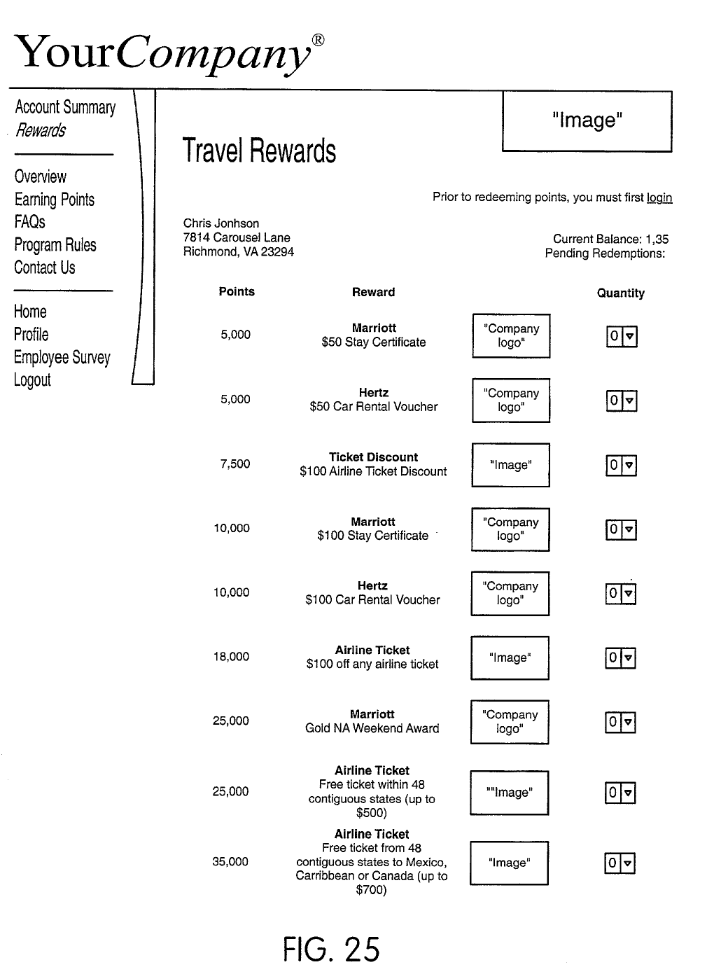

For travel redemptions 396, employees may be provided access to an external online ticket booking engine such as FareAgent® (powered by Sabre) 398 and can book their travel immediately. For airline tickets, for example, customers can choose from a list of available flights and can communicate seating preferences and the like. Companion tickets can also be booked, showing additional cost to the user. The system allows for credit card processing to pay for this additional cost. All tickets are electronic and a paper itinerary is mailed to the employee's home address. Other travel services, such as, lodging and car rental may also be provided. A sample travel redemption page is shown in FIG. 25.

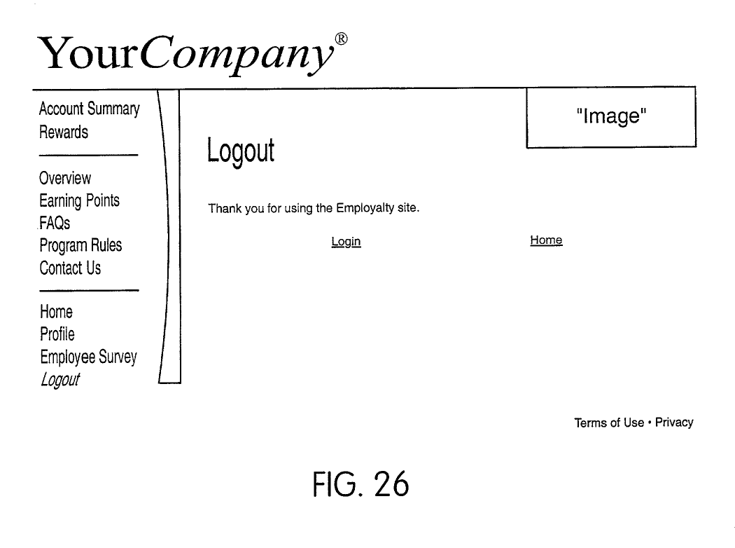

When the employee desires to exit the employee module, they select the logout option 391, which terminates their access. Upon logout, the employee is directed to the logout screen, as depicted in FIG. 26.

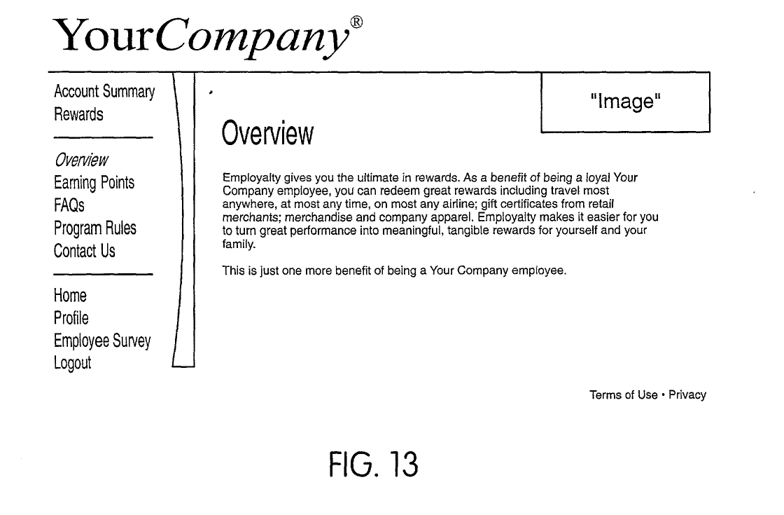

Each of the pages shown in FIGS. 7-26 are predeveloped web pages. Thus, the start-up and development cost for any one employer's employee incentive program is relatively low. Each page can be easily customized to include the employee's name and/or relevant logo. In addition, the system has additional flexibility such that the per point redemption value and the award option can be customized for each employer, based on the employer's needs and the demographics of the employer's employees.

In addition to the features listed above, the employee module 300 can be further customized to provide interesting content and access to special services that help employees manage their personal lives without sacrificing their work performance. For example, the employee module could be customized to provide information such as news, sports scores, weather, and stock quotes or services such as a reminder service or golf tee-time reservation service. The module could also contain information such as a “joke of the day,” office polls, a fantasy football competition, or a daily trivia question. Such features would help draw attention to the employee module, making it the place from which the employee begins their day. In addition to this “recreational” material, the employee module could also serve as an important employer communication vehicle. A portion of the employee module could be set aside to allow the employer to pass along current news concerning the employer and relevant benefit information. Additionally, this section could provide links to a pension system so that the can, for example, check his 401(k) performance and see how much vacation time he has accrued.

As discussed above, in addition to the administrative module 200 and employee module 300, the employee loyalty program 100 provides for interconnectivity 400 to various external systems 500, to include Human Resources Information Systems (HRIS), payroll, and compensation systems. The interconnectivity is designed to limit the amount of time the employer 120 will need to spend performing data administration on the program. In order to establish and maintain multiple levels of manager/administrator 130 access, as described above, HRIS periodically uses the interconnectivity 400 to update the employment status of the manager/administrator. Using this interconnectivity functionality, additions, changes, and terminations of employees can be automatically updated into the employee loyalty program 100. In addition, data feeds such as employee anniversary dates and attendance information from the HRIS system can facilitate the distribution of points to employees through the administrative module 200. This data as well as any other information which affects many employees is tracked by HRIS and can be useful to users of the employee loyalty system 100.

In an alternative embodiment, in addition to the interconnectivity 400 described above, the employee loyalty program could provide for interface with the employer's 120 major benefits providers in areas such as employee assistance, insurance, and financial management. These interfaces would allow the employee loyalty program 100 to fully incorporate the benefit programs of these providers directly in the employee module 300. For example, an employee could submit an online health insurance claim or adjust 401k contribution account allocations

During operation of the employee loyalty program, the employer 120 purchases “points” from the program provider 110, which will be deposited into a point “bank.” By “points” is meant units of predefined value. For example, the employer could purchase 1,000,000 points for, e.g., $10,000 or $30,000, depending on the per-point redemption value the employer wants to attach to the points. By “bank” is meant a common source from which managers/administrators allocate points to employees. The point bank corresponds to an electronic memory location for storing the number of points available to the employer for issuing to selected employees. The employer module also enables the employer to access the point bank memory location. When a manager/administrator 130 allocates a quantity of points to an employee 140, that quantity of points is automatically deducted from the point bank and added to the employee's account. When the point bank has decreased enough so that the employer desires to replenish it, the employer 120 purchases more points from the program provider 110. Employees 140 accumulate points for performing various meritorious tasks or reaching certain milestones. When an individual employee's total point value reaches the predefined point value for a particular award, the employee may choose to redeem it 145. When this occurs, the program provider 110 supplies the award to the employee 140 and the employee's point balance is automatically reduced by the amount of the predefined point value for that award. For example, an employee with an initial point value of zero may earn 1500 points for meeting a sales quota and 2000 points for reaching a 1-year anniversary milestone. These points will be added to the employee's account by a manager 130, and the employer's point bank will be automatically decreased by a total of 3500 points. The employee's total point value would increase to 3500 points. If the employee chooses to receive a piece of merchandise with a predefined point value of 3000 points, the program provider 110 will process the redemption, ship the merchandise 145 to the employee, and automatically deduct 3000 points from the employee's point balance, leaving the employee with a total point value of 500 points.

The method of the present invention incorporates a very low expectation of breakage. In the context of an employee loyalty program, breakage refers to the principle that when loyalty points are issued to an employee, only a small percentage are actually redeemed during a particular fiscal cycle, if at all. In traditional employee loyalty models, the employer does not pre-pay or pre-fund points that it distributes to employees. The points are carried as a liability by the employer until redemption. At the time of redemption, the program provider deducts the points from the employee's account and bills the employer for the cost of the redeemed item. In general, 25% of issued points can be expected to be unredeemed due to expiration or employee attrition. Additionally, employee redemption frequency can vary significantly. As a result, it is very difficult for the employer to predict the program cost and budget for it from one fiscal cycle to the next. Another shortcoming of traditional loyalty programs is that the program provider issues points without receiving any return on investment until they are redeemed.

The method of the current invention corrects these problems by allowing the employer to pre-fund points on a regular cycle. Thus, regardless of employee redemption fluctuations, the cost to the employer is fixed. No breakage is expected, because points forfeited upon employee termination will be returned to the employer's point bank for reallocation. Further, it is expected that there will be a larger number of redemption options at a low point value than with traditional loyalty programs, encouraging more frequent usage of points. Also, because the employer pre-pays for the points, the program provider has an opportunity to earn investment income in the time period between issuance and redemption of points. Another feature of the present invention that will help to provide the program provider a measure of predictability of potential financial impact will be monthly and yearly caps on the amount of points that can be awarded to a particular employee. This will allow the program provider to minimize the financial impact of a large redemption or series of redemptions by a single employee.

Thus, the employee loyalty program of the current invention provides distinct advantages over traditional loyalty programs to all involved: the program provider, the employer, and employees. The program provider receives predictable income with an opportunity to earn valuable investment income. For the employer: employee retention is improved; the employer develops a company brand image, appearing cutting edge to employees and prospective employees; administrative costs are reduced by eliminating a cumbersome paper-based program; and employees are driven to the program website due to the recreational content and 24 hour per day/7 day per week availability. Finally, employees receive clearly defined and consistently applied incentives; they have convenient access to their account balance and reward options; they can have program questions answered online; and they have the convenience of online award redemption.

Although a preferred embodiment is specifically illustrated and described herein, it will be appreciated that modifications and variations of the present invention are covered by the above teachings and within the purview of the appended claims without departing from the spirit and intended scope of this invention.

What is claimed is:

1. A computer implemented employee loyalty system whereby an employer may issue reward points to selected ones of the employer's employees in response to the selected employees engaging in behavior that the employer wishes to encourage, said reward points being redeemable by the employee for an award, said system comprising:
a points bank memory location for storing the number of points available to the employer for issuing to selected employees;
an employee points memory location for storing the points issued to the selected employees;
an employer administrative module providing the employer with on-line access to said points bank memory location and said employee points memory location to enable the employer to transfer a specified number of points from the points bank memory location to a portion of the employee points memory location corresponding to an account of a selected employee to whom the employer wishes to issue reward points; and
an employee module providing each employee with on-line access to (a) the portion of said employee points memory location corresponding to the account of that employee to enable each employee to monitor the number of points in the employee's account, and (b) a reward point redemption page to enable the employee to redeem at least a portion of the reward points in the employee's account for an award,
wherein said employer administrative module and said employee module are interconnected over a distributed computer network.

2. The system of claim 1 further comprising interconnectivity to external systems.

3. The system of claim 2 wherein said external systems include at least one of human resource information systems, payroll systems, and compensation systems.

4. The system of claim 2 wherein said external systems include employer benefit providers.

5. The system of claim 1 wherein said distributed network comprises a network selected from the group comprising a local area network, a wide area network, and the Internet.

6. The system of claim 5 further comprising interconnectivity to external systems.

7. The system of claim 6 wherein said external systems include at least one of human resource information systems, payroll systems, and compensation systems.

8. The system of claim 1 wherein said employer administrative module includes one or more activity pages selected from the group comprising: a page which permits a user to add, remove, or modify administrative users; a page which permits an authorized user to display point purchase history; a page which permits an authorized user to view standard reports; a page which permits an authorized user to add, remove, or modify employees; a page which permits an authorized user to access help screens; a page which permits an authorized user to create and void point transactions.

9. The system of claim 1 wherein said employee module includes one or more pages selected from the group comprising: a page which presents to a user program information; a page which presents to a user security and privacy information; a page which presents to a user frequently asked question information; a page which provides a user with access to customer service; a page with presents to a user an account summary; a page which enables a user to perform account maintenance; a page which presents to a user an employee survey; and a page which enables a user to perform award redemption.

10. The system of claim 9 wherein said award redemption includes at least one of merchandise redemption; dining redemption; and travel redemption.

11. The system of claim 10 wherein said travel redemption includes direct access to an external online booking engine.

12. The system of claim 1 wherein said employee module is customizable to provide recreational material.

13. The system of claim 1 wherein said employee module is customizable to provide employer specific information.

14. A method for providing an on-line employee loyalty program, said method comprising:
providing reward points to an employer, whereby an employer may issue the reward points to selected ones of the employer's employees in response to the selected employees engaging in behavior that the employer wishes to encourage, said reward points being redeemable by the employee for an award;
providing an on-line employer communication portal accessible to the employer via a computer, said employer communication portal being constructed and arranged to enable the employer to request and manage reward points and to issue reward points to respective accounts of the selected employees;
providing an on-line employee communication portal accessible to employees of the employer via a computer, said employee communication portal being constructed and arranged to enable the employee to access the employee's account to monitor the number of accumulated reward points; and
providing an on-line reward point redemption portal accessible to the employees through said employee communication portal, said reward point redemption portal being constructed and arranged to enable the employee to select one or more awards for which to redeem a specified number of reward points accumulated in the account of the employee.

15. A computer readable medium having instructions encoded thereon for causing an electronic computer system to implement a method for providing an on-line employee loyalty program, said method comprising:
providing reward points to an employer, whereby an employer may issue reward points to selected ones of the employer's employees in response to the selected employees engaging in behavior that the employer wishes to encourage, said reward points being redeemable by the employee for an award;
providing an on-line employer communication portal accessible to the employer via a computer, said employer communication portal being constructed and arranged to enable the employer to request and manage reward points and to issue reward points to respective accounts of the selected employees;
providing an on-line employee communication portal accessible to employees of the employer via a computer, said employee communication portal being constructed and arranged to enable the employee to access the employee's account to monitor the number of accumulated reward points; and
providing an on-line reward point redemption portal accessible to the employees through said employee communication portal, said reward point redemption portal being constructed and arranged to enable the employee to select one or more awards for which to redeem a specified number of reward points accumulated in the account of the employee.

16. A method for providing an points-based employee incentive program, said method comprising;
evaluating demographics of an employer's employees;
providing reward points to the employer, whereby the employer may issue the reward points to selected ones of the employer's employees in response to the selected employees engaging in behavior that the employer wishes to encourage;
providing a first communication link between the employer and the employee enabling the employer to issue reward points to the employee;
providing an award option that includes a selection of awards including awards chosen based on the demographics of the employees, wherein said reward points issued by the employer to the employee are redeemable by the employee for an award selected from the award option;
maintaining an inventory of awards contained in the award option;
proving a second communication link enabling the employee to communicate a redemption request and award selection; and
providing to the employee, in response to said redemption request and award selection, the selected award from said inventory of awards.

17. The method of claim 16, wherein said first and second communication links comprise communication portals implemented on a distributed computer network.

18. The method of claim 17, wherein said distributed computer network is the internet.

19. The method of claim 17, wherein said distributed computer network is the employer's intranet.

20. The method of claim 16, wherein said award option includes one or more items selected from the group of items comprising: magazine subscriptions, merchandise, company branded items; resort packages, airline travel, and gift certificates of specified value redeemable for merchandise, dining, hotel, or car rental.

21. The method of claim 16, further comprising providing, via said first communication link, additional informative content.

22. The method of claim 16, further comprising providing a third communication link enabling the exchange of information with external systems.

23. The method of claim 22, wherein said external systems comprising one or more systems selected from the group comprising: employer human resource information systems; compensation systems, payroll systems; pension systems, employee assistance systems, financial management systems, and insurance systems.

24. The method of claim 16, further comprising providing a pre-defined reward point earning activity matrix defining a plurality of behaviors the employer wishes to encourage among the employees and associated reward points earned for each behavior.

25. The method of claim 16, wherein providing said award option comprises providing a pre-defined reward point-award option matrix specifying a plurality of possible awards for which an employee may redeem reward points and an associated number of reward points required for each possible award.

26. The method of claim 25, further comprising providing an associated award value for each possible award.

27. The method of claim 16, comprising providing said first communication link on a communication portal implemented on a distributed computer network and providing via said communication portal one or more functionalities selected from the group of functionalities comprising:
(a) searching for employee accounts by account number, social security number, or employee name;
(b) adding and deleting employee accounts;
(c) monitoring and revising reward point balances in employee accounts;
(d) revising employee passwords;
(e) monitoring reward point balances in employer's account; and
(f) monitoring employee reward point redemptions.

28. The method of claim 16, comprising providing said second communication link on a communication portal implemented on a distributed computer network and providing via said communication portal one or more items selected from the group of items comprising:
(a) account summary;
(b) customer service information;
(c) program information;
(d) account maintenance; and
(e) employee surveys.
